(19) United States
(12) Patent Application Publication
(10) Pub. No.: US 2019/0058615 A1
(43) Pub. Date: Feb. 21, 2019

(54) METHOD AND APPARATUS FOR PROGRAMMABLE AND FLEXIBLE MULTI-DOMAIN L2/L3 IP/MPLS VPN SERVICE PROVISIONING USING A DYNAMIC SERVICE MODEL

(71) Applicant: NOKIA SOLUTIONS AND NETWORKS OY, Espoo (FI)

(72) Inventors: Mohammad Reza ROKUI, Ottawa (CA); David A. WATKINSON, Ottawa (CA)

(21) Appl. No.: 15/679,906

(22) Filed: Aug. 17, 2017

(51) Int. Cl. H04L 12/46; H04L 29/06; H04L 12/931; H04L 12/24

(52) U.S. Cl. CPC H04L 12/4633; H04L 12/4641; H04L 61/256; H04L 49/70; H04L 41/50; H04L 63/0272

(57) ABSTRACT

Various embodiments relate to a method and apparatus for programmable and dynamic approach for end-to-end multi-domain L2/L3 service placement in telecommunications networks including defining a DSM policy by defining each of a plurality of service realms, assigning a plurality of nodes to the plurality of service realms, assigning service-type flags to each of the plurality of nodes, assigning internetworking flags to at least one of a plurality of internetworking nodes and applying the DSM policy during L2/L3 service creation. The DSM policy also can be defined to include all possible paths between any two endpoints in the context of a service.

### TECHNICAL FIELD

This disclosure relates generally to defining an end to end Internet Protocol/Multiprotocol Label Switching (“IP/MPLS”) Virtual Private Network (“VPN”) for programmable and dynamic service placement, and more specifically, but not exclusively, to E2E multi-domain L2/L3 service provisioning.

### BACKGROUND

There are no existing automated, steerable solutions to the problem of creating inter-domain services.

The current automated solutions rely on Border Gateway Protocol (“BGP”) to control the creation of inter-domain services. These automated solutions are inefficient at steering traffic based on traffic engineering requirements as these automated solutions merely provide a fault recovery mechanism.

These automated solutions require complex BGP configuration and are error-prone due to complex interactions between various BGP policies that might coexist in a customer network.

For example, the current steerable solutions are based on independent manual configuration of the services in each domain. These solutions have complex configuration requirements and are error-prone. In addition, there is minimal fault recovery at the domain boundaries.

There are automated steerable solutions to inter-domain Peer-to-Peer (“P2P”) Label Switched Path (“LSP”) tunnel creation through H-PCE and through the multi-domain support, but these solutions do not provide the flexibility and the policy management needed for service creation.

For example, to create a L2 E-Line multi-domain service between endpoints, EP1 and EP2, using the current automated solution would require finding the existing points between different service domains, finding the exit routers from one technology to another technology, finding the optimal path considering the constraints and objectives (e.g., bandwidth, cost, latency, hop), finding the resources (e.g., LSPs, tunnels) needed to be used and/or created in each domain, provisioning all of the resources to the network, creating the individual services in each domain and provisioning the entire service by stitching together different service types (e.g., ERP G.8032, VLAN-Uplink, L3 VPN and PW-based E-Line services).

Using the current automated solution, the final multi-domain service may not be optimal, and the provisioning may be time consuming.

### SUMMARY OF EXEMPLARY EMBODIMENTS

A brief summary of various embodiments is presented below. Embodiments address the need to create a programmable and dynamic service for E2E multi-domain L2/L3 service provisioning while considering the network and service resources currently consumed in the network.

In order to overcome these and other shortcomings of the prior art and in light of the need to create a programmable and dynamic service for E2E multi-domain L2/L3 service provisioning while considering the network and service resources currently consumed in the network., a brief summary of various exemplary embodiments is presented. Some simplifications and omissions may be made in the following summary, which is intended to highlight and introduce some aspects of the various exemplary embodiments, but not to limit the scope of the invention.

Detailed descriptions of a preferred exemplary embodiment adequate to allow those of ordinary skill in the art to make and use the inventive concepts will follow in later sections.

Various embodiments described herein relate to a method for end-to-end multi-domain service placement in telecommunications networks including defining a service-realm Dynamic Service Model (“DSM”) policy by creating a physical topology of a network, defining each of a plurality of service realms in the network, assigning a plurality of nodes to the plurality of service realms, assigning service-type flags to each of the plurality of nodes and assigning internetworking flags to at least one of a plurality of internetworking nodes and applying the DSM policy during L2/L3 service creation.

In an embodiment of the present disclosure, the method for end-to-end multi-domain service placement in telecommunications networks further includes defining the DSM policy by assigning Service Realm Policy (“SRP”) to each of the plurality of service realms.

In an embodiment of the present disclosure, the method for end-to-end multi-domain service placement in telecommunications networks further includes defining the DSM policy by assigning templates and scripts to each of the plurality of service realms.

In an embodiment of the present disclosure, assigning the capability flags to each of the plurality of nodes is automatic.

In an embodiment of the present disclosure, assigning the capability flags to each of the plurality of nodes is manual.

In an embodiment of the present disclosure, the service creation employs resources, where the resources include one of IP/MPLS, VPN or pseudowires.

In an embodiment of the present disclosure, the internetworking flags identify which of the plurality of nodes are capable of switching between technologies.

Various embodiments described herein relate to a non-transitory machine-readable storage medium encoded with instructions for end-to-end multi-domain service placement in telecommunications networks, the medium including instructions for defining a service-realm Dynamic Service Model (“DSM”) policy by creating a physical topology of a network, defining each of a plurality of service realms in the network, assigning a plurality of nodes to the plurality of service realms, assigning service-type flags to each of the plurality of nodes and assigning internetworking flags to at least one of a plurality of internetworking nodes and instructions for applying the DSM policy during L2/L3 service creation.

In an embodiment of the present disclosure, the non-transitory machine-readable storage medium, further includes instructions for defining the DSM policy by assigning Service Realm Policy (“SRP”) to each of the plurality of service realms.

In an embodiment of the present disclosure, the non-transitory machine-readable storage medium, further includes instructions for defining the DSM policy by assigning templates and scripts to each of the plurality of service realms.

In an embodiment of the present disclosure, assigning the capability flags to each of the plurality of nodes is automatic.

In an embodiment of the present disclosure, assigning the capability flags to each of the plurality of nodes is manual.

In an embodiment of the present disclosure, the service creation employs resources, where the resources include one of IP/MPLS, VPN or pseudowires.

In an embodiment of the present disclosure, the internetworking flags identify which of the plurality of nodes are capable of switching between technologies.

Various embodiments described herein relate to a method for end-to-end multi-domain service placement in telecommunications networks, including defining an implicit-service Dynamic Service Model (“DSM”) policy by creating a network topology, assigning service-type flags to each of the plurality of nodes, assigning inter-networking capability flags to routers in the network topology and defining all possible paths between all endpoints and creating the DSM policy which describes all possible paths between all of the endpoints; applying the DSM policy during L2/L3 service creation.

In an embodiment of the present disclosure, the capability flags are assigned manually.

In an embodiment of the present disclosure, the capability flags are inferred.

In an embodiment of the present disclosure, a YANG module defines content of the DSM policy.

In an embodiment of the present disclosure, service realms are inferred from the DSM policy.

In an embodiment of the present disclosure, the service creation employs resources, where the resources include one of IP/MPLS, VPN or pseudowires.

In an embodiment of the present disclosure, the internetworking flags identify which of the plurality of nodes are capable of switching between technologies.

Various embodiments described herein relate to a non-transitory machine-readable storage medium encoded with instructions for end-to-end multi-domain service placement in telecommunications networks, the medium including instructions for defining an implicit service Dynamic Service Model (“DSM”) policy by creating a network topology, assigning service-type flags to each of the plurality of nodes, assigning inter-networking capability flags to routers in the network topology and defining all possible paths between all endpoints and creating the DSM policy which describes all possible paths between all of the endpoints; applying the DSM policy during L2/L3 service creation.

In an embodiment of the present disclosure, the capability flags are assigned manually.

In an embodiment of the present disclosure, the capability flags are inferred.

In an embodiment of the present disclosure, a YANG module defines content of the DSM policy.

In an embodiment of the present disclosure, service realms are inferred from the DSM policy.

In an embodiment of the present disclosure, the service creation employs resources, where the resources include one of IP/MPLS, VPN or pseudowires.

In an embodiment of the present disclosure, the internetworking flags identify which of the plurality of nodes are capable of switching between technologies.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

These and other more detailed and specific features are more fully disclosed in the following specification, reference being had to the accompanying drawings, in which:

FIG. 1 illustrates a service-realm DSM topology;

FIG. 2A illustrates an implicit-service DSM solution in an IP/MPLS service provider;

FIG. 2B illustrates paths to connect any two endpoints in the network;

FIG. 3 illustrates a diagram of network elements and various pathways from each endpoint;

FIG. 4 illustrates a flow diagram for a method for end-to-end multi-domain service placement using service-realm DSM solution; and

FIG. 5 illustrates a flow diagram for a method for end-to-end multi-domain service placement using implicit-service DSM solution.

### DETAILED DESCRIPTION OF THE INVENTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable.

The embodiments of an end to end IP/MPLS VPN service for service placement with a Dynamic Service Model (“DSM”) policy which defines the multi-domain end to end programmable services, provides the dynamic service modeling and can be defined using the YANG data model, defines multi-domain services (i.e., composite services), allows multiple overlay models over routing and physical topologies, does not change the service abstract models from the view point of customers of service provides, can be employed by service provisioning applications for an end to end path search logic during VPN service creation, and is extensible to provide services using new technology, such as EVPN.

As the Software-Defined Network (“SDN”) controller contains both IP/MPLS path placement and service fulfillment functionalities, the L2/L3 VPN service provisioning functionality provides the operator with an abstract service API either to create a new L2/L3 service or to modify the existing service.

The service provisioning logic receives the request and based on the optional policies, profiles and templates, finds the resources in the network such as MPLS LSPs, tunnels, QoS, OAM, Service Sites and Pseudowires (“PW”) and deploys them to the network.

Telecommunications networks are evolving, including for example, the IP/MPLS, optical transport and wireless networks which support many L2/L3 VPN services.

The L2/L3 IP/MPLS services are the engine of a telecommunications service provider for connectivity to their VPN customers.

SDN requires flexible and agility service for creation, modification and management of L2/L3 IP/MPLS VPN services. In a SDN, a network administrator may shape traffic from a centralized control console without having to control individual switches and can deliver or modify the L2/L3 services to wherever they are needed in the network, without regard to what specific devices are connected to the network.

The embodiments disclosed herein address the need for a service for provisioning and management of L2/L3 IP/MPLS for creation and modification of services. The embodiments may be implemented by any SDN controller which has the end to end visibility of the IP/MPLS network.

The embodiments described herein may be employed by service providers to dynamically create or modify their end to end VPN services and may provide a means for service providers to define or modify their L2/L3 services using the YANG data model.

Furthermore, the embodiments described herein allow the service providers to define their L2/L3 VPN services considering the network and service resources currently consumed in the network and define its E2E multi-domain L2/L3 services, which allows programmability and flexibility of E2E multi-domain L2/L3 service to customers and allows flexible creation of multi-domain services with different technologies, such as PW-based or EVPN-based, different service types such as E-Line, E-LAN and L3 VPN, and different transport types such as RSVP, Segment Routing (“SR”), LDP, GRE, G.8032 ERP and so on.

To allow the programmability of service provisioning using DSM, two types of capability flags are proposed: service type flags and internetworking flags.

These two types of flags will be assigned to each network elements.

These two types of flags may also be inferred for each network element.

The service-type flags identify the service types supported by each network element in the network. A network element may be assigned more than one flag. The service type flag includes the technology type based on the service type over the transportation type.

Technology types may include PW (T-LDP), PW (BGP), PW (manual), and EVPN. Service types may include E-Line, E-LAN, and L3 VPN. Transportation types may include RSVP-TE, SR-TE, LDP, BGP, GRE, VLAN-Uplink, ERP, Optical, and PBB.

For example, a service type flags may be a PW-based E-Line over RSVP-TE, an EVPN-based E-LAN over LDP, an E-Line over PBB, or a L3 VPN over SR-TE.

Further, for example, if a network element is capable of supporting both EVPN and PW-based E-Line over RSVP, the flags, PW-based E-Line over RSVP-TE and EVPN-based E-Line over RSVP-TE will be assigned.

These flags are meaningful on SDN controller and not deployed to the network.

The internetworking flags identify nodes which are capable of switching between technologies.

For example, a “MS-PW switching capable” router is capable of switching between two E-Lines.

Further, for example, internetworking flags may be MS-PW-Switching, PW-EVPN-Switching, E-Line E-LAN-Switching, E-Line L3 VPN-Switching, E-LAN-L3 VPN-Switching, PCE Capable and so on.

Similar to service type flags, these flags are meaningful on SDN controller and not deployed to the network. A network element can be assigned multiple Capability Flags.

These flags will be employed by service fulfillment and service provisioning functionality of the SDN controller to mark the border between service realms and find an optimal end to end IP/MPLS path between any endpoints.

Two embodiments are included to create flexibility and programmability during the L2/L3 service provisioning and service fulfillment.

The first embodiment is a service-realm DSM solution, where the network operator defines the service domains (i.e. service realms) explicitly in DSM policy using the capability flags (i.e. service flags and inter-networking flags). The DSM policy may then be used during the service provisioning.

The second embodiment is an implicit-service DSM solution, where the network operator defines capability flags (i.e. service flags and inter-networking flags). The service realms will be indirectly inferred.

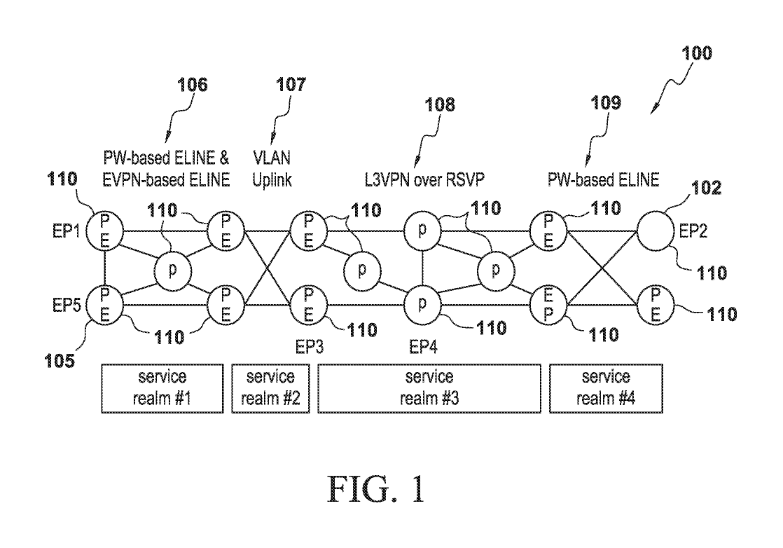

In a first embodiment, FIG. 1 illustrates the first solution with the service realm DSM topology 100. The DSM policy defines the E2E multi-domain service topology.

A service realm is a group of network elements which supports the same service types. The multi-domain E2E service includes multiple endpoints, EP1-EP5 (101, 102, 103, 104 and 105), multiple service realms including for example the PW-based E-Line & EVPN-based E-Line 106, VLAN Uplink 107, L3 VPN over RSVP 108, PW-based E-Line 109, and network elements 110 within those service realms which support the same set of services.

For example, FIG. 1 illustrates four service realms, PW-based E-Line & EVPN-based E-Line, VLAN Uplink, L3 VPN over RSVP, and PW-based E-Line.

Each service realm includes the network elements 110, P and PE, which support the same set of services. The solution is flexible such that for example if a network element supports certain services, the operator can intentionally not use them because of for example certain service provider policies.

Each network element 110 knows its service realm number and each network element 110 has a service-type flag and may have multiple service-type flags.

Network element P indicates those which are not on the edge of a service realm while network elements PE indicate those which are on the edge of a service realm.

The end points may be in any service realm.

Service realms may be IGP areas, IGP levels, BGP AS, physical VLAN uplinks but in general a service realm is independent of physical and routing topologies.

The service-realm DSM solution requires defining the DSM policy by defining all the service realms, assigning service realms to all the nodes, assign the “service-type flags” to all the nodes (either automatically or manually) (i.e., assign service-type flags to service realms), assigning the “inter-networking flags” to all or a subset of inter-networking nodes, optionally assigning Service Realm Policy (SRP) and templates/scripts to each service realm, and finally use the DSM during the L2/L3 service creation. Using the SRP, for example, may influence the SDN controller to prefer one service type over another or include and exclude some network elements during the E2E path search.

Using the templates/scripts also allows the flexibility both during the service creation and after the service creation. For example, it may be needed to enable the Bidirectional Fault Detection (“BFD”) after L2/L3 service creation, auto-assign the L3 VPN route target (“RT”) and route distinguisher (“RD”) or assign specific L3 VPN import/export policies. All these can be achieved using templates/scripts assigned to each service realm. As a result, the assignment of Service Realm Policy and templates/scripts for each service realm make the E2E service provisioning flexible and programmable.

Operators may define any number of DSMs for their networks. DSM is flexible and allows network operator to define multiple DSMs. A network operator may define the DSM per Network-Slicing (e.g. DSM1 for slice1 and DSM2 for slice2), DSM per customer (e.g. DSM1 for customer 1 and DSM2 for customer 2) or DSM per service type (e.g. DSM1 for L3 VPN and DSM2 for EVPN-based services).

The inter-networking flags identify those nodes in the network which are capable of switching between technologies.

For example, those routers with “MS-PW switching capable” flags are capable of switching between two E-Lines (multi-segment pseudo wire).

By allowing assignment of inter-networking flags, an operator can allow SDN controller to use those routers as service realms border routers during the path selection.

Although network elements 110 may be capable of inter-networking between E-Line-base PW and L3 VPN, inter-networking flags may be used on selected network elements 110 because of network operators' policy or mode of operation. This also provides another degree of flexibility and programmability for network operator during service creation.

For example, although endpoints are capable of inter-networking RSVP L3 VPN over LDP between E-Line base PW and L3 VPN, an operator may decide to enable the “inter-networking” flags for only one of the endpoints.

After the DSM policies are defined, the network operator could use them during the L2/L3 service creation. The DSM policies may be used during the service provisioning and path placement. The workflow for service creation is as follows. For example, suppose the network operator would like to create a L3 VPN service. If several DSM policies are defined, the network operator may decide to use DSM2 for creation of L3 VPN service between multiple endpoints. During the service creation, the operator may select DSM2, the operator may override Service Realm Policy (“SRP”) for some or all of the service realms, the operator may override templates/scripts which are assigned during DSM creation for some or all of the service realms. The SDN controller may use the DSM policy during the path search and resource placement to achieve an optimal E2E L3 VPN service between multiple endpoints. Finally, the SDN Controller may provision the necessary resource to the network using the device-specific instruction (e.g. Netconf/Yang, CLI or SNMP).

Finally, if any scripts and templates are defined for post-service creation, the may be used to direct the network elements in the service to perform any action (e.g. run BFD protocol between network elements or perform Y.1731 OAM tests in the network.

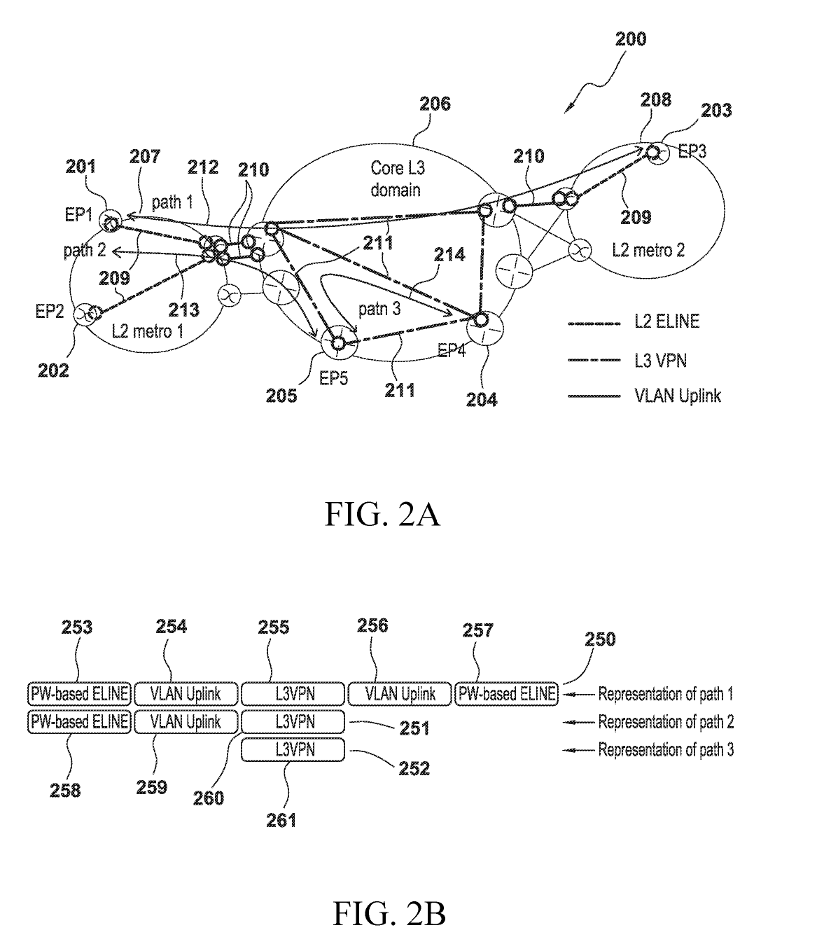

In a second embodiment, FIG. 2A illustrates the second approach which is “Implicit-Service DSM solution” in an IP/MPLS service provider 200.

Similar to “Service Realm DSM” method, the capability flags which includes both the service type flags and the inter-networking flags are defined for all network elements in the network. The capability flags can be assigned manually and may be inferred.

The difference between this embodiment and the previous embodiment (Service Realm DSM) is that the implicit-service DSM embodiment does not include an explicit definition of service realms (i.e., routers are not aware of service realms).

Because the service realm is not defined in the second embodiment, this embodiment requires that the operator specifies all possible E2E paths in multi-domain service definition. As a result, the content of the DSM policy will include all E2E in the network.

Referring to FIG. 2A, as an example to demonstrate this embodiment, the service provider may use the “implicit-service DSM solution” to dynamically create a L3 service between all endpoints from endpoint EP1 201 to endpoint EP5 205. The desired L3 VPN service includes placing and provisioning of VPN service in the Core L3 Domain 206 and finding the optimal resources on L2 metros, specifically L2 Metro 1 207 and L2 Metro 2 208 (such as interconnected nodes from L2 Metro 1 207 and L2 Metro 2 208 to Core L3 Domain 206), provisioning them to the network and stitching the L2 services to the L3 services using both E-Line services 209 and VLAN-Uplink services 210.

After all possible paths between endpoints are identified, the content of DSM policy will include all these paths. For example for FIG. 2A there all only three possible paths to connect any two endpoints in this network paths; path1, path2 and path3. In FIG. 2B, these three paths are shown where path 1 250, path 2 251 and path 3 252 represents the connectivity between two endpoints. For example, FIG. 2B illustrates path 1 250 which includes PW-based E-Line 253 to VLAN Uplink 254 to L3 VPN 255 to VLAN Uplink 256 to PW-based E-Line 257. Path 2 251 includes PW-based E-Line 258 to VLAN Uplink 259 to L3 VPN 260. Path 3 252 includes L3 VPN 261.

Despite the complexity for the service provider, it is important to note that the provisioned L3 services are abstract from the customer of the service provider. From the customer point of view, the service is just a L3 service between endpoint EP I 201 to endpoint EP5 205, which satisfies objectives and constraints, such as bandwidth, hop and latency. All the complexities of finding the resources in the network and provisioning them to the network is completely hidden from customer.

After defining the DSM policy, the “implicit-service DSM” solution in an IP/MPLS service provider 200 allows the service provider to find the optimal path between different all layer 2 metros (i.e., L2 Metro 1 207 and L2 Metro 2 208) and layer 3 core (i.e. Core L3 Domain 206), consider the constraints and objectives (e.g., bandwidth, cost, latency and hops). Then the SDN Controller will find the all resources needed to be used/created in each service domain (e.g., MPLS LSPs, tunnels), provision all the resources to the network, create the individual services in each domain and final create the entire service by stitching different services together.

The content of the DSM policy for this embodiment (i.e. implicit-service DSM) is different from the first embodiment (i.e. service-realm DSM). The content of DSM policy for this embodiment shows all the possible combinations of all the paths between any two endpoints. For example in FIG. 2A, all of the possible path are path 1, path 2 and path 3. As a result, the content of DSM policy has three rows where each row defines one path. Since there are three possible paths, the DSM policy contains three rows with a logical “OR” between them.

For example, path 1 212 will be a path from EP1 201 to EP3 203 which will use the following services: PW-based E-Line, VLAN Uplink, L3 VPN, VLAN Uplink, and PW-based E-Line.

For example, path 2 213 will be a path from EP1 201 to EP5, which will use the following services: PW-based E-Line; VLAN Uplink; and L3 VPN.

For example, path 3 214 will be a path from EP4 204 to EP5 205, which will use the following services: L3 VPN.

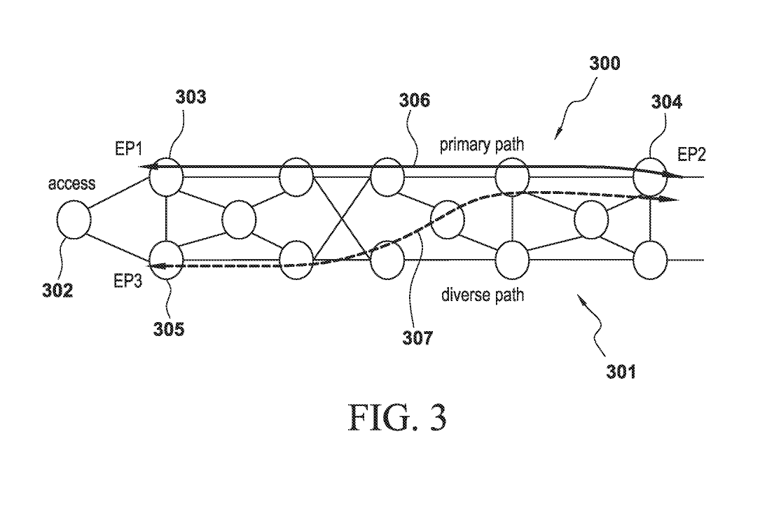

In another embodiment, FIG. 3 illustrates service diversity 300 for both core of the network 301 and access for the network 302. The core redundancy for E2E multi-domain from endpoint EP1 303 to endpoint EP2 304 may be supported by DSM policy by allowing two pathways between endpoint EP1 303 and endpoint EP2 304, where the pathway profile defines the path diversity, specifically a primary pathway 306 and a diverse pathway 307.

The access redundancy 302 for E2E multi-domain endpoint EP1 303 to endpoint EP2 304 or endpoint EP3 305 to endpoint EP2 304 may be supported by DSM policy by allowing two pathways endpoint EP1 303 to endpoint EP2 304 or endpoint EP3 305 to endpoint EP2 204, where the pathway profile defines the path diversity, specifically a primary pathway 306 and a diverse pathway 307. The access redundancy 302 for E2E multi-domain will be supported by DSM.

In both solutions to add another level of flexibility and programmability, the operator may want to run specific templates/scripts after the service creation (e.g., enable BFD in the network or use specific service template for a service creation).

DSM will support optional templates/scripts which may be assigned to either service-realms in service-realm DSM solution and to entire service in implicit-service DSM solution.

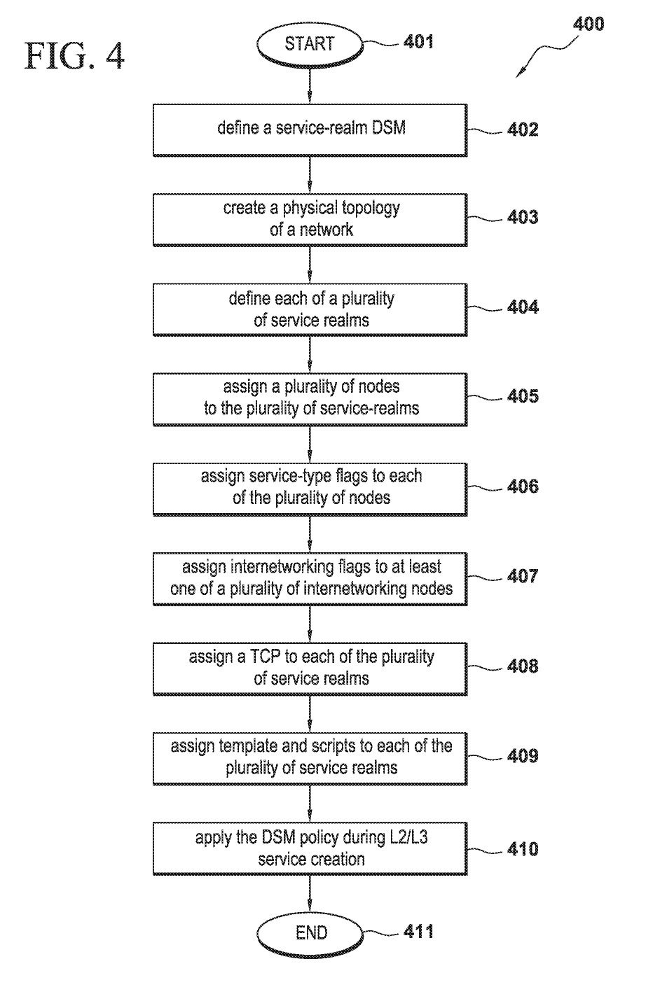

FIG. 4 illustrates a method for end-to-end multi-domain service placement 400 using “Service Realm DSM” embodiment. The method 400 begins at step 401 and proceeds to step 402 to define a service-realm DSM policy.

The method 400 proceeds to step 403 to use the network topology.

The method 400 proceeds to step 404 to define each of a plurality of service realms.

The method 400 then proceeds to step 405 to assign a plurality of nodes to the plurality of service realms.

The method 400 then proceeds to step 406 to assign service-type flags to each of the plurality of nodes.

The method 400 then proceeds to step 407 to assign internetworking flags to at least one of a plurality of internetworking nodes.

The method 400 then proceeds to step 408 to assign an optional “Service Realm Policy” (SRP) to each of the plurality of service realms.

The method 400 then proceeds to step 409 to assign optional templates/scripts to each of the plurality of service realms.

The method 400 then proceeds to step 410 to apply the DSM policy during L2/L3 service creation.

The method 400 then proceeds to end at step 411.

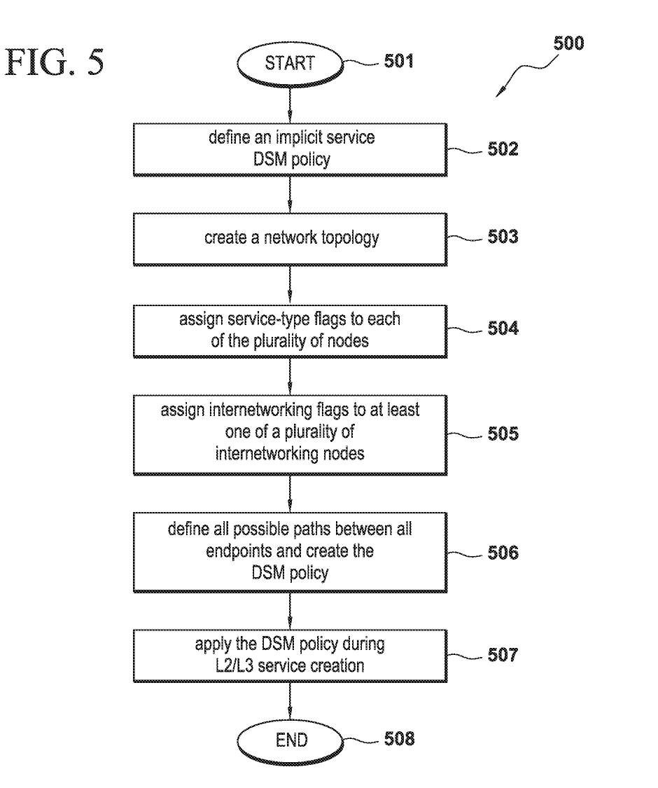

FIG. 5 illustrates a method for end-to-end multi-domain service placement 500 using “Implicit-Service DSM” embodiment.

The method 500 begins at step 501.

The method 500 proceeds to step 502 to define an implicit-service DSM policy.

The method 500 then proceeds to step 503 to use the network topology;

The method 500 then proceeds to step 504 to assign service-type flags to each of the plurality of nodes.

The method 500 then proceeds to step 505 to assign internetworking flags to at least one of a plurality of internetworking nodes.

The method 500 then proceeds to step 506 to define all possible paths between all the endpoints and then create the DSM policy which describe all possible paths between all endpoints.

The method 500 then proceeds to step 507 to apply the DSM policy during L2/L3 service creation.

The method 500 then proceeds to end at step 508.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for end-to-end multi-domain service placement in telecommunications networks, comprising:
defining a service-realm Dynamic Service Model (“DSM”) policy by:
creating a physical topology of a network;
defining each of a plurality of service realms in the network;
assigning a plurality of nodes to the plurality of service realms;
assigning service-type flags to each of the plurality of nodes; and
assigning internetworking flags to at least one of a plurality of internetworking nodes; and
applying the DSM policy during L2/L3 service creation.

2. The method for end-to-end multi-domain service placement in telecommunications networks of claim 1, further comprising defining the DSM policy by:
assigning Service Realm Policy (“SRP”) to each of the plurality of service realms.

3. The method for end-to-end multi-domain service placement in telecommunications networks of claim 1, further comprising defining the DSM policy by:
assigning templates and scripts to each of the plurality of service realms.

4. The method for end-to-end multi-domain service placement in telecommunications networks of claim 1, wherein assigning the capability flags to each of the plurality of nodes is automatic.

5. The method for end-to-end multi-domain service placement in telecommunications networks of claim 1, wherein assigning the capability flags to each of the plurality of nodes is manual.

6. The method for end-to-end multi-domain service placement in telecommunications networks of claim 1, wherein the service creation employs resources, where the resources include one of IP/MPLS, VPN or pseudowires.

7. The method for end-to-end multi-domain service placement in telecommunications networks of claim 1, wherein the internetworking flags identify which of the plurality of nodes are capable of switching between technologies.

8. A non-transitory machine-readable storage medium encoded with instructions for end-to-end multi-domain service placement in telecommunications networks, the medium comprising:
instructions for defining a service-realm Dynamic Service Model (“DSM”) policy by:
creating a physical topology of a network;
defining each of a plurality of service realms in the network;
assigning a plurality of nodes to the plurality of service realms;
assigning service-type flags to each of the plurality of nodes; and
assigning internetworking flags to at least one of a plurality of internetworking nodes; and
instructions for applying the DSM policy during L2/L3 service creation.

9. The non-transitory machine-readable storage medium of claim 6, further comprising instructions for defining the DSM policy by:
assigning Service Realm Policy (“SRP”) to each of the plurality of service realms.

10. The non-transitory machine-readable storage medium of claim 6, further comprising instructions for defining the DSM policy by:
assigning templates and scripts to each of the plurality of service realms.

11. The non-transitory machine-readable storage medium of claim 6, wherein assigning the capability flags to each of the plurality of nodes is automatic.

12. The non-transitory machine-readable storage medium of claim 6, wherein assigning the capability flags to each of the plurality of nodes is manual.

13. The non-transitory machine-readable storage medium of claim 6, wherein the service creation employs resources, where the resources include one of IP/MPLS, VPN or pseudowires.

14. The non-transitory machine-readable storage medium of claim 6, wherein the internetworking flags identify which of the plurality of nodes are capable of switching between technologies.

15. A method for end-to-end multi-domain service placement in telecommunications networks, comprising:
defining an implicit-service Dynamic Service Model (“DSM”) policy by:
creating a network topology;
assigning service-type flags to each of the plurality of nodes;
assigning inter-networking capability flags to routers in the network topology; and
defining all possible paths between all endpoints, and ’creating the DSM policy which describes all possible paths between all of the endpoints; applying the DSM policy during L2/L3 service creation.

16. The method for end-to-end multi-domain service placement in telecommunications networks of claim 11, wherein the capability flags are assigned manually.

17. The method for end-to-end multi-domain service placement in telecommunications networks of claim 11, wherein the capability flags are inferred.

18. The method for end-to-end multi-domain service placement in telecommunications networks of claim 11, wherein a YANG module defines content of the DSM policy.

19. The method for end-to-end multi-domain service placement in telecommunications networks of claim 11, wherein service realms are inferred from the DSM policy.

20. The method for end-to-end multi-domain service placement in telecommunications networks of claim 11, wherein the service creation employs resources, where the resources include one of IP/MPLS, VPN or pseudowires.

21. The method for end-to-end multi-domain service placement in telecommunications networks of claim 11, wherein the internetworking flags identify which of the plurality of nodes are capable of switching between technologies.

22. A non-transitory machine-readable storage medium encoded with instructions for end-to-end multi-domain service placement in telecommunications networks, the medium comprising:
instructions for defining an implicit service Dynamic Service Model (“DSM”) policy by:
creating a network topology;
assigning service-type flags to each of the plurality of nodes;
assigning inter-networking capability flags to routers in the network topology; and
defining all possible paths between all endpoints, and
creating the DSM policy which describes all possible paths between all of the endpoints; applying the DSM policy during L2/L3 service creation.

23. The non-transitory machine-readable storage medium of claim 14, wherein the capability flags are assigned manually.

24. The non-transitory machine-readable storage medium of claim 14, wherein the capability flags are inferred.

25. The non-transitory machine-readable storage medium of claim 14, wherein a YANG module defines content of the DSM policy.

26. The non-transitory machine-readable storage medium of claim 14, wherein service realms are inferred from the DSM policy.

27. The non-transitory machine-readable storage medium of claim 14, wherein the service creation employs resources, where the resources include one of IP/MPLS, VPN or pseudowires.

28. The non-transitory machine-readable storage medium of claim 14, wherein the internetworking flags identify which of the plurality of nodes are capable of switching between technologies.
